(19) United States
(12) Patent Application Publication
(10) Pub. No.: US 2006/0131243 A1
(43) Pub. Date: Jun. 22, 2006

(54) Method of treating an aqueous suspension of kaolin

(75) Inventors: Michael J. Garska, Sandersville, GA (US); Robert J. Pruett, Milledgeville, GA (US); Jun Yuan, Kathleen, GA (US); Christopher R. L. Golley, Cornwall (GB)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Imerys Pigments, Inc., Roswell, GA (US)

(21) Appl. No.: 10/531,470

(22) PCT Filed: Feb. 9, 2004
(86) PCT No.: PCT/US04/02011

§ 371 Date: Nov. 21, 2005

Related U.S. Application Data
(60) Provisional application No. 60/445,857, filed on Feb. 10, 2003.
(60) Provisional application No. 60/493,809, filed on Aug. 11, 2003.

(51) Int. Cl. C02F 1/52

(52) U.S. Cl. 210/732

(57) ABSTRACT

A method for the treatment of kaolin particulate material comprising: providing a dispersed aqueous suspension comprising kaolin particulate material and having a pH of at least about 7.5; selecting at least one selective flocculation polymer, wherein said at least one selective flocculation polymer has a measured anionicity ranging from about 1% to about 12%, such as from about 4.5% to about 8%; selectively flocculating said suspension into a first layer and a second layer by adding to said suspension said at least one selective flocculation polymer, and separating said first layer from said second layer.

This application claims priority to U.S. Provisional Patent Application No. 60/445,857, filed Feb. 10, 2003 and U.S. Provisional Patent Application No. 60/493,809, filed Aug. 11, 2003.

The present invention relates to a method of treating an aqueous suspension of kaolin particulate material with at least one selective flocculation polymer. An advantage of the inventive method may be the ability to separate impurities from the aqueous suspension, which may improve at least one property of the kaolin, including its whiteness, brightness, as well as other properties of the kaolin. The present invention also relates to the selection of selective flocculation polymers with a narrow range of measured anionicity. Advantages associated with selecting such a polymer may include, for example, improved productivity resulting from reduced settling times and reduced dosage of polymer, improved product variability resulting from more reproducible, consistent flocculation over time, and improved reduction in impurities, which may improve at least one of whiteness, brightness, and other properties of the kaolin.

Kaolin, or kaolinitic clay, is a mineral clay containing the particulate mineral kaolinite as its principal constituent. Such clays were formed in geological times by the weathering of the feldspar component of granite. Primary kaolin clays are those which are found in deposits at the site at which they were formed, and are generally present in a matrix of undecomposed granite, which must be separated from the clay during the refining process for the clay. For example, kaolin clays mainly of the primary type are obtained from deposits in South West England, France, Germany, Spain, and the Czech Republic. Secondary kaolin clays, which are alternatively known as sedimentary kaolin clays, are those which were flushed out in geological times from the granite matrix in which they were formed, and were deposited in an area remote from their site of formation, generally in a basin formed in the surrounding strata. For example, kaolin clays obtained from deposits in Georgia, South Carolina, and Alabama, USA are generally of the sedimentary (secondary) type.

Kaolin clay is refined and used as an ingredient, a pigment, and a filler material in a variety of application compositions, especially for filling and coating of paper, paper board, and like products. Kaolin is a white mineral and is often used in such application compositions to impart, among other properties, whiteness and brightness. However, one or more desirable properties of the kaolin may be adversely affected by the presence of impurities. Kaolin clays are generally found in association with impurities, which are often present in relatively small proportions. The composition and nature of the impurities can vary considerably, depending on the geographical region from which the kaolin clay is obtained. The impurities present can significantly affect various properties of the kaolin clay.

The present invention also relates to the treatment of kaolin clays containing separable impurities therein with a selective flocculation polymer, such as a selective flocculation polymer with a narrow range of measured anionicity, in order to reduce the amount of such impurities present in the kaolin clays. The present invention further relates to the treatment of kaolin clays containing separable impurities therein with a selective flocculation polymer manufactured in a continuous process and having a narrow range of measured anionicity, to reduce the amount of such impurities that are present.

Particular impurities, which when present in kaolin are often desirable to remove, include titanium compounds present as, for example, titania. This impurity is colored and its presence adversely affects the whiteness and brightness of the kaolin. The titania often contains at least a small percentage of associated iron oxide, which either stains the surface of the titania crystals or acts as a substituent in the titania lattice. It is the colored iron oxide associated with, but not easily separable from, the titania, which principally causes the unwanted whiteness and brightness reduction. Titania impurities are found mainly in sedimentary kaolins, for example from the southeastern United States, and it is often desirable to remove such impurities from such kaolins.

Other impurities, for example, quartz, mica, phosphates, fine clay impurities such as certain smectite clay constituents, and various other species, e.g., compounds containing transition elements such as iron, may also be present, and may be undesirable in many kaolin product applications. In general, such impurities may be found in either primary or sedimentary kaolin clays. However, the nature and amount of the impurity types present will vary between clay types.

Improving the properties of kaolin clays, especially the whiteness and brightness of kaolin clays, by the separation therefrom of separable impurities such as titania and iron oxides, has been a problem facing the kaolin industry. While selective flocculation has proven to be a possible solution to this problem, variability in the flocculation process has been found to create undesirable variability in many kaolin product applications. Many attempts have been made to solve this problem but none has been entirely satisfactory.

When particles of mineral ore or powder mixtures are sufficiently large, for example, larger than 325 (U.S.) mesh, the components of the mixture can be separated by simple physical means such as air or magnetic separation. When particles are finer, more sophisticated technology may be needed to bring about efficient separations. It is conventional to make the separation of finely divided mineral, e.g., particles finer than 325 mesh, by forming the mixture into an aqueous suspension or slurry and providing physical and/or chemical treatments that will bring about a desired separation.

Certain physical beneficiation processes such as magnetic separation (e.g., as described in WO 98/50161A) and particle size classification, e.g., by centrifuging (e.g., as described in U.S. Pat. No. 4,018,673), have been applied. Likewise, certain chemical beneficiation methods have been proposed for employment to separate fine impurities, especially discoloring titania impurities, from kaolin clays to improve their properties, such as their brightness. For example, for this purpose flotation has been described in U.S. Pat. No. 3,655,038, froth flotation has been described in U.S. Pat. No. 4,472,271 and EP 0 591 406, and leaching has been described in U.S. Patent No. 4,650,521. Substantial industrial use has been made of froth flotation; however, this process is expensive to operate.

Selective flocculation is a procedure that is widely used commercially to separate finely divided minerals and powders. In the case of clay, some processes utilize anionic polymers to selectively flocculate the clay, leaving the impurities, such as titanium, in the form of titania, dispersed and amenable to subsequent separation from the clay. Commercial variants of selective flocculation employ weakly anionic polymers such as hydrolyzed polyacrylamide to selectively flocculate impurities in the precipitate, leaving the purified clay dispersed in the supernatant. See, for example, U.S. Pat. Nos. 3,371,988, 3,701,417, 3,837,482, 3,862,027, 4,227,920, 4,604,369, 5,535,890, 5,685,900, and WO 98/5788.

In U.S. Pat. No. 3,701,417 and WO 98/57888, the process described is of a kind operated under conditions such that the titania and other impurities are separated in a flocculated layer and the product is recovered from a deflocculated layer. In other instances, the titania and other impurities are separated in a deflocculated layer. Separating the impurities in a flocculated lower layer, or so called underflow layer, is not fundamentally an efficient process because a significant amount of kaolinite, e.g., 20% or more, typically 30% to 45% by weight, of the feed material becomes entrained with the impurity, e.g., titania. Separating the impurity in a deflocculated layer is much more efficient, e.g., the amount of kaolinite present in the impurity layer can be small, e.g., at most a few per cent by weight. The present invention also relates to use of selective flocculation of the latter type, wherein the separable impurities such as titania are separated in a deflocculated upper, or so-called overflow, layer.

The methods of the latter type, i.e., which involve separating impurities in a deflocculated layer, as described in the aforementioned prior patents, are not effective and versatile, for example, as compared with the method of the present invention, at least because they rely on the use of a particular feed kaolin and/or on the use of one or more preceding beneficiation steps. For example, the method of U.S. Pat. No. 5,685,900 requires the feed clay itself to be fine and bright and to have been pre-treated by particle size classification and oxidative bleaching prior to selective flocculation. The method of U.S. Pat. No.4,227,920 relies on prior treatment of the feed kaolin by high gradient magnetic separation and grinding. The method of the invention beneficially is not limited by the source of the feed clay or the need for preceding beneficiation steps.

One theory for the success of selective flocculation is that the polymer is selectively absorbed. To achieve selective adsorption of a flocculating agent on a particular component of a mixture, a number of methods have been suggested in the literature [Yu and Aftia; in “Flocculation in Biotechnology and Separation Systems,” (Y. A. Attia, ed.) p. 601, Elsevier, Amsterdam 1987; Behl, S. and Moudgil, B. M., Minerals and Metallurgical Processing, 5, 92,1992 and, Behl, S. and Moudgil, B. M., Journal of Colloidal Interface Science, 160,1993]. Because clay particles are naturally charged on their surfaces, it is much easier and more effective to flocculate the clay particles rather than the impurities.

One aspect of the present invention is a method of treating an aqueous suspension of kaolin particulate material, whereby impurity particles are separated from the kaolinite in the material by selective flocculation of the kaolinite and deflocculation of impurity particles. This method comprises the selection of a selective flocculation polymer with a narrow range of measured anionicity. Desirably, the treatment allows such separation to be carried out efficiently, more effectively, and/or in a more versatile manner than prior art treatments.

This and other objects may be met by the method of the invention and any benefits thereby obtained will become apparent from the description later in this specification.

According to one aspect of the present invention, there is provided a method for the treatment of kaolin particulate material comprising:
(a) providing a dispersed aqueous suspension comprising kaolin particulate material and having a pH of at least 7.5;
(b) selecting at least one selective flocculation polymer, wherein said at least one selective flocculation polymer has a measured anionicity ranging from about 1% to about 12%.
(c) selectively flocculating said suspension into a first layer and a second layer by adding to said suspension said at least one selective flocculation polymer; and
(d) separating said first layer from said second layer.

According to a second aspect of the present invention, there is provided a method for the treatment of kaolin particulate material comprising:
(a) providing a dispersed aqueous suspension comprising kaolin particulate material and having a pH of at least 7.5;
(b) selecting at least one selective flocculation polymer, wherein said at least one selective flocculation polymer has a narrow range of variability for measured anionicity and has a measured anionicity ranging from about 1% to about 12%;
(c) selectively flocculating said suspension into a first layer and a second layer by adding to said suspension said at least one selective flocculation polymer; and
(d) separating said first layer from said second layer.

According to a third aspect of the present invention, there is provided a method for the treatment of kaolin particulate material comprising:
(a) providing a dispersed aqueous suspension comprising kaolin particulate material and having a pH of at least 7.5;
(b) selecting at least one selective flocculation polymer, wherein said at least one selective flocculation polymer has been manufactured by a continuous process and has a measured anionicity franging from about 1% to about 12%;
(c) selectively flocculating said suspension into a first layer and a second layer by adding to said suspension said at least one selective flocculation polymer; and
(d) separating said first layer from said second layer.

The kaolin particulate material treated by the method of the invention may contain at least 0.1% by weight, in many cases at least 1.0% by weight, and in some cases at least 1.5% by weight, of at least one impurity such as, for example, titania and/or mica, based on the dry weight of the kaolin. The titania, if present, may comprise the anatase and/or rutile form of TiO₂.

Other undesirable impurities, especially fine impurities, associated with kaolin, such as one or more of feldspar, silicates such as quartz, clay mineral impurities such as smectites and other kandites, phosphates and metal oxides, e.g., of iron and other transition metals, may, alternatively or in addition to titania and mica, be separated by the method of the invention either used alone or in conjunction with one or more other known beneficiation processes.

The dispersed aqueous suspension may be formed by mixing dry kaolin particulate material with water. Alternatively, the suspension may be formed by taking an existing suspension of kaolin particulate material and adding water as needed. In either case, a dispersant may be needed. When blunged, an aqueous suspension may have a solids content of at least 35%, for example, ranging from about 40% to about 70% or more by weight. When flocculated, an aqueous suspension may have a solids content of less than 35%, for example, ranging from about 5% to about 20% by weight or from about 10% to about 15%.

The pH in steps (a) and (c) is desirably at least about 7.5, for example, at least about 9.5, or at least about 10.2. In one embodiment, the pH ranges from about 10.5 to about 12.5, such as about 11.5. According to one aspect of the invention, the adjustment of pH to a value of at least about 9.5 is carried out suitably before addition of the polymer in step (c).

Where selective flocculation has been applied industrially in the prior art to remove impurities from kaolin, the pH has generally been not greater than 9.5. The benefit of using, in conjunction with conditioning, a higher pH for selective flocculation of kaolinite especially aimed at separation and removal in a deflocculated form of fine titania has not previously been recognized.

Use of a selective flocculation process to treat kaolin at a higher pH is known from U.S. Pat. No. 3,539,003 and subsequent GB-A-2059811B. However, the treatments described in those documents are directed at treating kaolin clays from England which do not contain separable titania. Furthermore, in the method of U.S. Pat. No. 3,539,003, it was considered essential to add an additive such as a calcium salt to provide multivalent ions. No such additive is required in the Method of the invention.

At least 95%, in many cases at least 97%, by weight of the kaolinite present in the aqueous suspension in step (a) may be separated and recovered from the flocculated product layer in step (d) in the method of the invention. At least 20% by weight, e.g., at least 30% to at least 40% by weight or more, for example, at least 50% by weight, of the impurities present in the aqueous suspension in step (a) may be separated from the deflocculated product layer in step (d) by the method of the invention. Further TiO₂ content and other impurities may be separated by one or more other conventional beneficiation processes, which may be applied, for example, after the selective flocculation separation process.

“Dispersed aqueous suspension” refers to an aqueous suspension, wherein insoluble and possibly soluble components are uniformly-dispersed in a medium, such as water. Dispersal of the insoluble and possibly soluble components may be facilitated by one or more pH modifiers, dispersants, deflocculants, etc.

“Selective flocculation” refers to the combination or aggregation of a select subset of insoluble particles caused by the addition of at least one suitable flocculation polymer to a suspension of a kaolin particulate material. By increasing the effective particle size of the insoluble components present in the suspension, the efficiency of solid/liquid separation techniques (i.e., separation of impurities) is improved.

“Measured anionicy” (or measured charge density) refers to the total charge density, which includes charge resulting from the copolymerization reaction (i.e., theoretical charge density), plus the charge contribution originating from hydrolysis of functional groups.

“Narrow range of variability” refers to a narrow range of variability in a measured property on a batch-to-batch basis. The range of variability is deemed to be narrow when the measured property over fifteen batches has a 3 sigma of +/−10% of the measured mean.

“Separation” refers to the removal of the supernatant, which primarily contains the impurities, from the precipitate, which primarily contains the kaolin particles, following selective flocculation.

It has been found, surprisingly and beneficially, that the method of the present invention, wherein the selective flocculation polymer is specifically selected such that it has a measured anionicity ranging from about 1% to about 12% may improve the productivity by providing reduced settling times and allowing for reduced dosage of polymer. In one embodiment, the selective flocculation polymer is selected such that has a measured anionicity ranging from about 4.5% to about 8%, such as from about 6% to about 7%. The present invention may also allow for reduced product variability by providing a more reproducible process, and may also allow for a reduction in impurities, which may improve at least one of whiteness, brightness, and other properties of the kaolin. It has been found, surprisingly and beneficially, that the method of the present invention, wherein the selective flocculation polymer is selected from polymers with a narrow range of variability for measured anionicity, such as those manufactured by a continuous process, may improve productivity and reduce product variability.

Another benefit of the method of the present invention is that it allows titania-containing impurities and other fine, undesirable impurities in kaolin to be reduced to levels such that other conventional kaolin treatment processes, which may also beneficially be used in treatment of the kaolin, may be applied more effectively. For example, such other processes, which may be applied after selective flocculation, may comprise one or more of oxidation; particle size classification; comminution, e.g., by grinding using particulate grinding media; magnetic separation; bleaching; and dewatering.

A further benefit of the method of the invention is that it may be applied as at least one of various stages of a multi-stage kaolin beneficiation route. For example, it is possible to apply the method of the invention before other beneficiation stages, such as before one or more of oxidation, comminution (for example, grinding), particle size classification (for example, centrifugation), magnetic separation, and bleaching. Thus, the kaolin particulate material employed in the method of the invention may comprise crude kaolin which, apart from an optional degritting step applied before or during the method, need not be subject to any other particle separation or beneficiation steps until after treatment by the method of the invention.

A still further benefit is that the fineness and brightness of the feed kaolin treated by the method of the invention are not critical for the method to be effective, as distinct from prior art methods, e.g., as described in U.S. Pat. No. 5,685,900. For example, the kaolin treated by the method of the invention may comprise a coarse crude kaolin clay having a (water washed) GE brightness of less than 70, e.g., in the range of from 20 to 70, although kaolin having a GE brightness of greater than 70 may also be treated by the method. All brightness values referred to herein are as measured according to the standard TAPPI procedure T-646 05-75.

The accompanying drawings, which are incorporated in and constitute a part of this specification, illustrate one possible embodiment of the invention and together with the description, serve to explain, but not limit, the principles of the invention.

### BRIEF DESCRIPTION OF THE DRAWINGS

FIG. 1 is a diagrammatic flow sheet of a method of treating an aqueous kaolin suspension in accordance with an embodiment of the invention.

FIG. 2 is a graph comparing remaining titania after selective flocculation versus % anionicity of the selective flocculation polymer.

FIG. 3 is a graph comparing needed dosage of selective flocculation polymer versus % anionicity of the selective flocculation polymer.

FIG. 4 is a graph comparing settling times after selective flocculation versus % anionicity of the selective flocculation polymer.

The method of the invention may be operated as a batch, semi-continuous, or continuous process.

The kaolin particulate material for treatment according to the method of the present invention may be selected from primary and secondary kaolin clays. In one embodiment, the kaolin particulate material is selected from secondary kaolin clays, for example, those obtained from one of the deposits in Georgia, USA. The starting material may comprise a substantially dry, kaolin particulate material, further comprising at least one impurity, for example, those chosen from titania and mica.

This starting material may be treated by adding water and at least one optional dispersant (dispersing agent) thereto to produce the dispersed aqueous suspension of step (a). In one embodiment, mechanical working, e.g., by blunging, can be applied to the aqueous suspension produced in step (a), whereby agglomerates present in the kaolin are broken down by the working process. The mechanical working is desirably carried out before any conditioning step and may be applied during step (a). Addition of dispersant and/or application of working may be applied in a batch, semi-continuous, or continuous process.

Non-limiting examples of suitable dispersants that may be included in the aqueous suspension of kaolin particulate material of step (a) include anionic dispersants, known to be useful in a deflocculation/selective flocculation separation process. For example, the dispersant may comprise an inorganic agent, such as an alkali metal silicate, e.g., sodium silicate or potassium silicate, or a condensed phosphate salt, such as sodium hexametaphosphate or sodium pyrophosphate. Alternatively, or in addition, the dispersant may comprise an organic agent such as a lignosulfonate, e.g., sodium lignosulfonate, or a polycarboxylate, e.g., a polyacrylate, such as a sodium polyacrylate.

If the dispersed aqueous suspension is treated by the mechanical working process, the particle solids concentration may be at least about 35%, for example, the concentration may range from about 40% to about 70% or more by weight. According to another aspect, the solids concentration in the suspension is at least about 50%, at least about 60%, or even about 70% or more by weight. A work input of at least 5 kJ/kg, for example, at least 15 kJ/kg, e.g., from 20 kJ/kg to 100 kJ/kg, may be applied during the mechanical working process.

Following step (a), including any mechanical working applied, the suspension may optionally be diluted and degritted to remove large particles still present therein.

The pH may be adjusted more than once prior to step (b). For example, the pH may be adjusted to be at least about 7.5, such as at least about 9.5, or to range from about 10.5 to about 12.5. In one embodiment, the pH is adjusted to about 11.5. Any pH adjustment may each be carried out by adding one or more suitable basic substances, for example, those chosen from alkali metal hydroxides and carbonates and ammonium hydroxides and carbonates, such as sodium hydroxide, potassium hydroxide, sodium carbonate and ammonium hydroxide. In one embodiment, sodium hydroxide is used as the pH adjusting additive.

It has been found that if the polymer is added soon after step (a), with the pH not being at least about 7.5, the resulting flocs are relatively fine and take a long time to settle. This is undesirable at least because it reduces product throughput. Furthermore, it has been found that this can increase the amount of impurity present in the underflow or product layer in the separation by selective flocculation.

An optional conditioning step may be applied before a pH adjustment, which would be prior to the addition to the suspension of the selective flocculation polymer in step (c). The optional condition step may improve the size and strength of the flocs, which are produced after the selective flocculation polymer has been added, and thereby improve the effectiveness and efficiency of the separation process, i.e., separation of kaolinite flocs from deflocculated impurities.

When applied, conditioning by ageing is carried out for a period of at least about 30 minutes, usually at least about 2 hours. Ageing for a period of at least about 5 hours, for example, for a period of at least about 8 to about 24 hours, or for a period of about 1 to about 7 days, prior to selective flocculation polymer addition, may be beneficial.

Where the optional conditioning step includes, in addition to or instead of ageing, the addition of at least one conditioning chemical, the at least one conditioning chemical is desirably added prior to ageing. One or more conditioning chemicals may, however, be added after some or all of the ageing. The conditioning chemicals may, for example, comprise one or more salts of a monovalent ion metal, for example one or more sodium salts. The sodium salt(s) may comprise an organic salt such as a salt of a polycarboxylate, or a halide, such as sodium chloride and/or sodium polyacrylate. Sodium polyacrylate may be employed as a mineral dispersant. In one embodiment, sodium chloride solution, having a concentration ranging from about 10% to about 25% by weight, is added to the clay slurry in an amount ranging from about 5 to about 40 pounds, for example, about 20 pounds per dry ton of kaolin particulate material.

The optional conditioning chemical(s) may be added to the kaolin suspension via one or more static in-line mixers. Alternatively, the chemical(s) can be added to the kaolin suspension in one or more conventional mixers using mechanical agitation means to ensure good mixing.

The optional conditioning step may be preceded by a pH adjustment step, after or during step (a). According to one aspect, the pH may be adjusted to at least about 6.5; for example, the pH may be adjusted to range from about 6.5 to about 9.5. According to another aspect, the pH may be adjusted to range from about 6.5 to about 7.5 at some time prior to the optional conditioning step.

The at least one selective flocculation polymer added in step (c) is suitably mixed with the kaolin suspension prior to delivery of the mixture of the two to the selective flocculation separator. Conveniently, these two ingredients are thoroughly mixed together prior to delivery to the separator. The at least one selective flocculation polymer may be added via one or more static in-line mixers. Alternatively, the at least one selective flocculation polymer can be added to the kaolin suspension in one or more conventional mixers using conventional mechanical agitation means to ensure good mixing. The at least one selective flocculation polymer may be added in one or more doses at one or more addition points prior to delivery of the suspension to the separator.

The feed aqueous suspension to be delivered to the selective flocculation separator may have a specific gravity in the range of from about 1.03 to about 1.15. The solids content of the suspension may accordingly be less than about 35%, such as in the range of about 5% to about 21%, e.g., about 10% to about 15%, by weight. Dilution with water may be carried out before the delivery to the separator, for example, before addition of the selective flocculation polymer.

The feed aqueous suspension to be delivered to the selective flocculation separator, e.g., after any optional conditioning and prior to selective flocculation polymer addition, may beneficially be heated. For example, the suspension may be heated by use of hot water in a water dilution stage and/or by passage of the suspension through an external heater, e.g., a heating jacket of a heat exchanger, e.g., to raise the temperature by at least about 10° C. In one embodiment, the suspension is heated from about 15-20° C. to about 30-35° C. or more.

The at least one selective flocculation polymer selected in step (b) and added to the suspension in step (c) of the method of the invention is chosen on the basis of the polymer's measured anionicity. U.S. Pat. Nos. 4,798,653 and 6,307,013 have reported standard flocculation polymers having a measured anionicity ranging from about 1% to about 40%. However, it has been discovered that distinct process and product advantages are possible where the measured anionicity ranges from about 1% to about 12%, for example, from about 4.5% to about 8% or from about 6% to about 7%, as reported in FIGS. 24.

Assessment of the anionicity (i.e., charge density) of a polymer can be reported in two ways. The first and more common practice is to report the molar percentage of the monomer (which contains the anionic charge group) in the monomer reaction feed. This percentage is referred to as the “theoretical” anionicity or “theoretical” charge density. For example, an acrylamide/acrylate copolymer derived from a mixture of monomers, wherein 10% of the monomers are acrylate monomers, has a theoretical anionicity of 10%.

The other method of reporting anionicity is based on a titration method that measures the “total” charge density of the test polymer. This method includes not only the charge density contributions from the monomers, but also includes the anionicity that results from hydrolysis of various groups that occurs during a polymerization reaction. For example, a hydrolysis reaction can convert a significant number of amide groups to carboxyl groups, as much as 7% for low charge density polymers (as in the case of the Floerger AN 905 PWG polymer). Without being bound by any particular theory or mechanism, it is believed that it is the total, or measured, anionicity that dictates how well a given polymer performs in the method of the invention.

A selective flocculant used in this invention can have any molecular weight that does not adversely effect the desired flocculation of the kaolin particles and deflocculation of the impurities. Higher molecular weights may provide improved flocculation performance. Typically, the average molecular weight will range from about 100,000 to about 50,000,000 or more. According to one aspect, the molecular weight is greater than about 100,000, for example, greater than about 1,000,000, and greater than about 10,000,000, provided the molecular weight does not adversely effect the desired flocculation reaction.

The organic polymers useful as the selective flocculation polymer in carrying out the method of the invention include, by way of example, water-soluble weakly anionic organic polyelectrolytes. Weakly anionic polymers may contain both anionic and non-ionic groups. Anionic properties may be imparted to synthetic non-ionic organic polymers, for example by the presence of side chains of anionic groups, such as carboxylic acid, carboxylic anhydride and carboxylic acid salt groups. Non-ionic groups in a side chain in the polymer may also be present, resulting from the presence of certain hydrophilic groups, e.g., one or more of the following hydrophilic groups: carboxylic acid amide, carboxy alkyl ester, pyrrolidone, hydroxy, hydroxy alkyl ether and alkoxy.

The anionic features of the polymeric flocculants can be imparted by any appropriate chemical constituents present on the polymer. Anionic polymers containing carboxyl, carboxymethyl, phosphate and sulfate functionalities, for example, are suitable for the invention. Non-limiting examples of suitable flocculants according to this invention include anionic polyacrylamides and anionic polysaccharides.

Because of their commercial availability, high molecular weight weakly anionic synthetic polymers, such as polyacrylamides containing some replacement, for example from 1% to 4% by weight of amide groups by carboxylic groups, are also suitable for the purposes of the invention. Such polyelectrolytes are prepared by copolymerization of the non-ionic monomer(s), e.g., acrylamide, and one or more suitable carboxylic acids, e.g., acrylic acid, or by the partial hydrolysis of non-ionic polymer(s), e.g., polyacrylamide. Polyacrylamides with carboxyl groups represent one preferred class of flocculants for use in this invention. In one embodiment, the at least one selective flocculation polymer is selected from acrylamide/acrylic acid copolymers, such as ULTIMER 00LT053 from ONDEO Nalco Co.

The at least one selective flocculation polymer may be added to the suspension in the form of a powder, a suspension, or a solution. The concentration of the polymer in the suspension, after being added to the suspension in step (c) of the method of the invention, may range from about 0.01% to about 0.5%, such as from about 0.05% to about 0.5% by weight based on the dry weight of kaolin present. When provided as a solution or suspension, the at least one selective flocculation polymer may be diluted in the solution/suspension to a concentration ranging from about 0.025% to about 0.25%, such as from about 0.05% to about 0.1% by weight, based on the total weight of the solution. In one embodiment, the at least one selective flocculation polymer is added to the suspension in the form of a solution, wherein the polymer is present at a concentration of about 0.075% by weight, based on the total weight of the solution.

The at least one selective flocculation polymer selected in step (b) and added to the suspension in step (c) of the method of the invention may be chosen on the additional basis that the at least one selective flocculation polymer has a narrow range of variability for measured anionicity. Heretofore, batch to batch variability in the measured anionicity of the polymer has not been a concern of manufacturers and consumers of flocculation polymers. Yet the present inventors have discovered that variability, presumably in the manufacturing process, results in variability in measured anionicity and, consequently, variability in selective flocculation and final kaolin product quality and yield. It has been discovered that certain selective flocculation polymers have a narrow range of variability for measured anionicity, particularly selective flocculation polymers manufactured by continuous processes.

In the selective flocculation processes of step (c), when the at least one selective flocculation polymer is added to the suspension, a flocculated phase containing kaolin particles forms and settles as a dense, viscous, gelatinous bottom layer; the top layer is a dispersed fluid suspension containing the deflocculated impurities. In the instance where a kaolin clay is selectively flocculated in this manner, the bottom layer contains a high percentage of the kaolin particles present and some impurities, and the top layer contains a high percentage of impurities and a small amount of kaolin particles.

The specific gravity of the supernatant or deflocculated impurity-containing aqueous layer produced by separation from kaolinite in the selective flocculation process in step (c) of the method according to the invention may be about 1.001 or more, e.g., in the range about 1.001 to about 1.03. Adjustment of the specific gravity may be made by adjustment of the dose of the at least one selective flocculation polymer added to the suspension to be treated. In one embodiment, the process of measuring specific gravity of the supernatant with a hydrometer, adding additional polymer while mixing, and allowing the flocs to settle is repeated until the specific gravity is less than about 1.004. A specific gravity of about 1.004 or less may ensure high recovery of the precipitate or flocculated clay, while minimizing the loss of fines in the supernatant.

Following formation of the layers in step (c), the layer of deflocculated impurities may be separated from the layer of flocculated kaolin particles in step (d) by conventional means, e.g., elutriation, decanting or siphoning using batch operation or in a continuous separator. The flocculated kaolin suspension extracted in step (d) may be further treated in a known manner, for example, by optional high shear pumping or mixing to break up the flocs, followed by one or more further beneficiation processes, e.g., one or more of oxidation, comminution (e.g., grinding), particle size classification (e.g., screening and/or centrifugation), magnetic separation, bleaching, washing, and dewatering (e.g., spray drying). Treatment with an oxidizing agent may oxidize residual polymers and other oxidizable impurities present in the suspension following the selective flocculation process.

After separation of the flocculated kaolin product suspension and before further processing of the same, the pH of the flocculated kaolin product suspension may be reduced in a well-known way by adding an acidic substance, for example to a pH of about 7 or less.

Prior to or during further processing, the flocculated kaolin suspension extracted in step (d) may be further treated in at least one additional selective flocculation step in order to provide even further purification of the kaolin. For example, the suspension obtained may be cleaned by washing with clean water, and treated by repeating one or more of the steps previously applied prior to selective flocculation polymer addition. Further selective flocculation polymer, which may be the same as or different from that selected in the earlier step (b) and employed in the earlier step (c), may then be added at the appropriate stage. The suspension is again allowed to separate in a selective flocculation separator, and the respective layers formed are subsequently extracted as in the earlier selective flocculation and extraction steps.

The separated and extracted impurity-containing deflocculated material may be discarded or further treated to recover, purify, and use ingredients therein, such as TiO₂. Water in the material may be separated by dewatering and may be purified and recycled for re-use in the same process or in a different process in a known manner.

As described earlier, the resulting kaolin, optionally after at least one additional further processing step, may show at least one property superior to those obtained by prior art processes. The resulting kaolin may, for example, have the following product properties:
% residual TiO₂:<0.7% by weight (based on the dry weight of kaolin);
GE brightness: at least 88, such as at least 91.

Although the invention is effective in treating kaolin-containing inorganic particulate materials having a wide range of particle size properties, it is also suitable for producing fine materials suitable for use as pigments in paper products. For example, the product produced may have the following properties:

mean particle size: from about 0.2 μm to about 5 μm, e.g., from about 0.2 μm to about 1.5 μm;

percentage (by weight) of particles having a size less than 2 μm: at least 60%, in some cases at least 80%, for very fine clays at least 90% by weight.

In this specification, titania and iron oxide amounts are as measured by a Philip Minimate™ GXPS1 analyzer fitted with a 10 kV/0.15 mA Sn X-ray source using approximately 1 g of dried and milled powder for the measurement.

In this specification, particle size (equivalent spherical diameter) distribution and mean size measurements are as measured in a well known manner by sedimentation of a fully dispersed dilute suspension of the particles in a standard aqueous medium using a SEDIGRAPH™ 5100 machine supplied by Micromeritics Corporation.

General Procedure

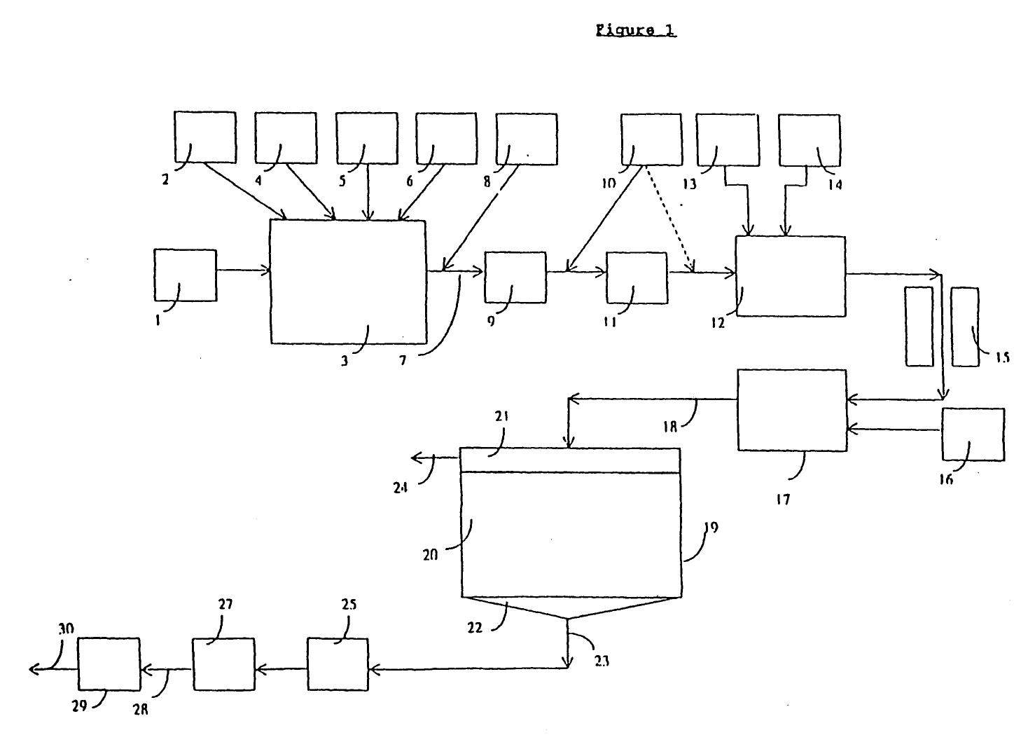

A general and typical embodiment of a method of the the present invention is illustrated in FIG. 1, which shows the processing involving selective flocculation for beneficiation of a crude kaolin clay. In the following description, percentage by weight values given for additives are, unless otherwise stated, percentages by weight of dry or active amounts of the additives based upon the dry weight of the inorganic particulate material present in the treated suspension.

As seen in FIG. 1, crude, particulate kaolin clay obtained from Georgia, USA is delivered as a substantially dry solid material from a source 1 together with water from a source 2 to a blunger 3. An aqueous suspension having a solids content of at least about 35% by weight, e.g., from about 40% to about 70% or more by weight, is formed in the blunger 3.

The following ingredients are optionally added to the suspension being treated in the blunger 3: (a) inorganic dispersant, e.g., sodium hexametaphosphate and/or sodium silicate, from a source 4; (b) alkali, e.g., sodium hydroxide or sodium carbonate, from a source 5; and (c) organic polyelectrolyte dispersant, e.g., sodium polyacrylate, from a source 6. The dispersant may typically comprise about 5 pounds of sodium hexametaphosphate (active basis) per dry ton of clay and/or from about 4 to about 6 pounds of sodium silicate (active basis) per dry ton of clay. The sodium silicate may have a molecular ratio of 3.2 Na₂O:1.0 SiO₂. The sodium hexametaphosphate may have a molecular ratio of 1.1 NaO:1.0 P₂O₅, and may be obtained from Calgon Corporation, Pittsburgh, Pa. In some cases, sodium polyacrylate may also be delivered together with the sodium hexametaphosphate to the blunger 3. A base, e.g., sodium hydroxide (NaOH) or sodium carbonate (Na₂CO₃) may be added to the slurry in the blunger 3 to adjust the pH to a given level.

The materials from the sources 1, 2, 4, 5, and 6 are thoroughly mixed and worked together in the blunger 3. Mechanical working of the aqueous suspension of kaolin in the blunger 3 is applied to break down agglomerates of solid particles. The resulting dispersed suspension has a pH of about 6.4 to about 7. An output stream 7 comprising the dispersed suspension after treatment in the blunger 3 is supplied, optionally after dilution with water from a source 8, to a degritter 9 where large particles, are separated and removed. The dispersed suspension may be passed through a Cowles mixer or similar high shear device to provide liquid working. If utilized, the high shear device is preferably after, rather than before, the degritter 9 in order to reduce wear on the mixing blade.

The degritted kaolin suspension is then delivered to a conditioning tank 11 where the suspension is allowed to stand with gentle mechanical stirring for an ageing period, e.g., for at least 30 minutes, for example, for several hours or days. Before and/or after conditioning by ageing, optional conditioning chemical, e.g., a sodium halide and/or a sodium polycarboxylate, may be added from a chemical additive source 10. For example, about 5 to 40 pounds (active NaCl) per dry ton of clay with about 20 pounds being typical may be added from source 10. The sodium chloride may be added to the degritted kaolin suspension through use of static mixers.

The suspension is optionally delivered to a mixer 12, which may be an in-line static mixer. The suspension may optionally be diluted by addition of water from a source 13 to adjust the specific gravity of the suspension. The pH of the suspension is adjusted to be about 9.5 or greater by addition of alkali such as sodium hydroxide or sodium carbonate from a source 14. An output stream from the mixer 12 comprising the kaolin suspension plus additives having a low solids concentration for example of from about 10% to about 15% by weight and a pH of at least about 9.5, such as about 11.5. The suspension is optionally passed through a heater 15 (e.g., a heat exchanger), which heats the suspension to a temperature of ranging from about 30° C. to about 40° C.

A stream of the suspension either from the conditioning tank 11 or that has been optionally heated by the heater 15 is delivered to a mixer 17, which may be an in-line static mixer, where at least one selective flocculation polymer comprising a high molecular weight polyacrylamide/polyacrylic acid polymer added from a source 16. If the at least one selective flocculation polymer is determined to have a relative anionicity in the range of about 4.5% to about 8%, the polymer is added during continuous mixing of the suspension.

The at least one selective flocculation polymer is selected by a titration process. 100 ml of deionized water and 3.0 ml of polymer solution (0.075% concentration) are added to a 250 ml beaker and allowed to stir for 1 minute. 6.0 ml of 0.001 N polydiallyl dimethylammonium chloride (PolyDADMAC) from BTG Mutek is slowly added to the mixture from a 10 ml burette, and stirring is maintained for an additional minute. 0.15 N NaOH is added dropwise, such that the pH is basic but below about 9.5. 3-4 drops of an indicator solution, such as, for example, toluidine blue, is added to the mixture until a uniform aqua-blue color is achieved. The mixture is then titrated with potassium polyvinyl sulfate (PVSK) from BTG Mutek from a 10 ml burette until the end point is reached; a light violet /purple. The amount of PVSK in ml needed to titrate the mixture is compared against the amount in ml need to titrate a blank and to titrate the standard, such as 346 polymer from NALCO, which has a known anionic charge density of 5.4. The relative anionicity, as measured against the standard is determined by equation 1:

$$[ \frac{\begin{matrix}( ml PVSK to titrate blank - \\ ml PVSK to titrate unknown polymer sample )\end{matrix}}{\begin{matrix}( ml PVSK to titrate blank - \\ ml PVSK to titrate known sample of 346 E polymer )\end{matrix}} ] \times 5.4 = relative anionicity$$

The output of the mixer 17 is a stream 18 of the suspension which is delivered as a feed to a separator 19 in which separation of kaolinite from impurities by selective flocculation takes place. Following this separation, a flocculated underflow layer 20 and a deflocculated overflow layer 21 are formed. A product stream 23 from the underflow layer 20 comprising beneficiated kaolin flocs is collected from the separator 19 at its base 22. A waste stream 24 comprising deflocculated impurities separated by the selective flocculation process in the overflow layer 21 is extracted from an upper region of the separator 19.

The suspension of kaolin in the product stream 23 is passed, optionally after shearing of the flocs therein by a shearing device 25, through an ozonizer 27 in which ozone gas is applied thereto. The concentration of ozone employed may range from, for example, about 0.01% to about 0.05% by weight. The ozone breaks down residual polymer and other oxidizable impurities, e.g., organic coloring contaminants, present in the suspension. An output stream 28 from the ozonizer 27 is delivered to a plant 29 in which the beneficiated kaolin suspension is further treated by conventional processing steps, such as bleaching, dewatering, spray drying, etc., to produce a commercially acceptable pigment product 30 available in dry or slurry form as required, e.g., having the properties described earlier.

### EXAMPLE

The following Example illustrates the benefits of a method embodying the invention as compared with the prior art. Where a percentage value of an ingredient or additive is stated, this is the percentage by weight on a dry or active basis based on the dry weight of kaolin present in the slurry.

A series of selective flocculation polymers with measured anionicities varying from about 1% to about 17% were studied in suspensions of kaolin clay comprising titania impurities. Each suspension was prepared from the same source of kaolin clay. For each suspension, 200 grams of the dry kaolin clay was diluted with water. The resultant suspensions had a solids concentration of about 10%. The pH of each suspension was then adjusted to about 11.5 with a 10% NaOH solution.

For each selective flocculation polymer studied, a solution comprising the selective flocculation polymer was prepared to a 0.075% strength. For example, 2.25 grams of polymer would be dissolved in 3000 grams of water.

Each polymer solution was added slowly to a known volume and weight of the suspension under continuous mixing conditions until flocs were visible. At that point mixing was suspended and the flocs permitted to settle. When the flocs had settled to one half the original volume, the specific gravity of the supernantant was measured by hydrometer. If the specific gravity was greater than 1.004, then flocs were resuspended with mixing and additional polymer solution added. The process was repeated until the specific gravity of the supernatant was 1.004 or less.

The total amount of polymer solution added was recorded. In addition, the time in seconds for the flocs to settle to one half the original volume was recorded. After the supernatant was decanted from the precipitate, the weight percent of titania remaining in the precipitate was recorded.

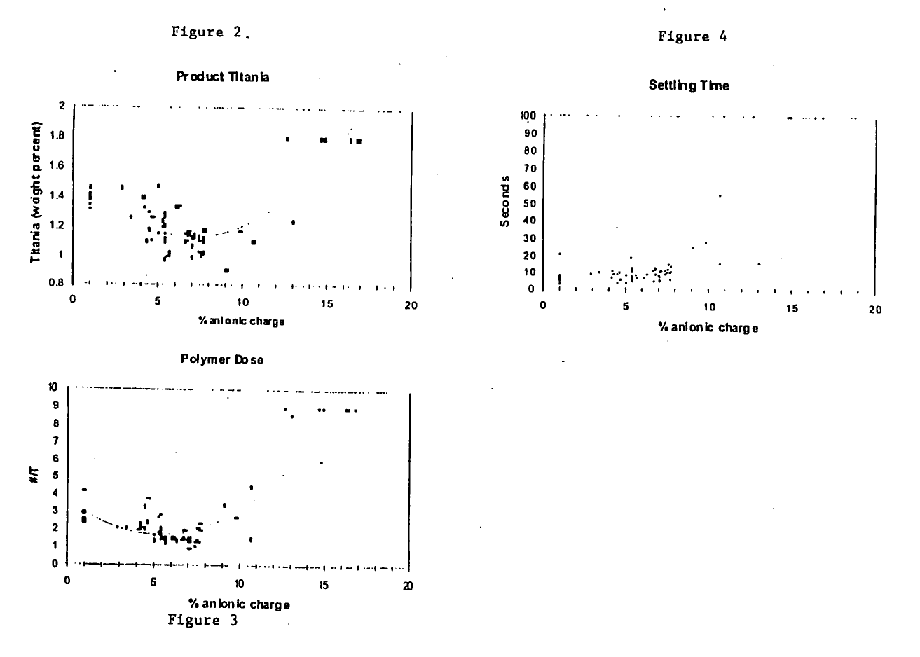

FIG. 2 graphs the recorded remaining titania (weight percent) versus the measured anionicity of the selective flocculation polymer. The graph indicates a possible operating range of approximately 1% to 12% and a narrowed operating range of approximately 6% to 9%. FIG. 3 graphs the dosage of selective flocculation polymer used (lbs of polymer/ton of clay) versus the measured anionicity of the selective flocculation polymer. The graph indicates a possible operating range of approximately 1% to 11% and a narrowed operating range of approximately 4% to 7%. FIG. 4 graphs settling times (seconds) the measured anionicity of the selective flocculation polymer. The graph indicates a possible operating range of approximately 1% to 10% and a narrowed operating range of approximately 2% to approximately 7%.

Other embodiments of the invention will be apparent to those skilled in the art from consideration of the specification and practice of the invention disclosed herein. It is intended that the specification and example be considered as exemplary only, with a true scope and spirit of the invention being indicated by the following claims.

What is claimed is:

1. A method for the treatment of kaolin particulate material comprising:
(a) providing a dispersed aqueous suspension comprising kaolin particulate material and having a pH of at least about 7.5;
(b) selecting at least one selective flocculation polymer, wherein said at least one selective flocculation polymer has a measured anionicity ranging from about 1% to about 12%;
(c) selectively flocculating said suspension into a first layer and a second layer by adding to said suspension said at least one selective flocculation polymer; and
(d) separating said first layer from said second layer.

2. A method according to claim 1, wherein said kaolin particulate material comprises a primary kaolin clay.

3. A method according to claim 1, wherein said kaolin particulate material comprises a sedimentary kaolin clay.

4. A method according to claim 1, wherein said kaolin particulate material comprises at least one impurity.

5. A method according to claim 4, wherein said at least one impurity is present in an amount of at least 0.1% by weight, based on the dry weight of the kaolin particulate material.

6. A method according to claim 5, wherein said at least one impurity is chosen from titania, anatase, smectite, iron oxide, and mica.

7. A method according to claim 1, wherein said dispersed aqueous suspension is provided by a process comprising including at least one dispersant with the aqueous suspension of kaolin particulate material.

8. A method according to claim 1, further comprising blunging said dispersed aqueous suspension.

9. A method according to claim 8, wherein said suspension comprises said kaolin particulate material in an amount of at least about 35% by weight, on a dry weight basis, prior to blunging.

10. A method according to claim 8, wherein said suspension comprises said kaolin particulate material in an amount ranging from about 40% to about 70% by weight, on a dry weight basis, prior to blunging.

11. A method according to claim 1, further comprising conditioning said dispersed aqueous suspension by allowing said suspension to age for a period of at least 30 minutes.

12. A method according to claim 11, further comprising conditioning said dispersed aqueous suspension by adding to said suspension at least one conditioning chemical.

13. A method according to claim 12, wherein said at least one conditioning chemical is added after said ageing.

14. A method according to claim 11, further comprising adjusting the pH of said suspension to a pH ranging from about 6.5 to about 7.5 prior to said ageing.

15. A method according to claim 1, wherein said pH is at least about 9.5.

16. A method according to claim 1, wherein said pH is in the range of from about 10.5 to about 12.5.

17. A method according to claim 1, wherein said pH is at least about 11.5.

18. A method according to claim 1, wherein said at least one selective flocculation polymer has a measured anionicity ranging from about 4.5% to about 8%.

19. A method according to claim 1, wherein said at least one selective flocculation polymer has a measured anionicity ranging from about 6% to about 7%.

20. A method according to claim 1, wherein said at least one selective flocculation polymer is chosen from water-soluble weakly anionic organic polyelectrolytes.

21. A method according to claim 1, wherein said at least one selective flocculation polymer is chosen from polyacrylamide copolymers.

22. A method according to claim 1, wherein said at least one selective flocculation polymer is chosen from polyacrylamide/polyacrylic acid copolymers.

23. A method according to claim 1, wherein said at least one selective flocculation polymer has a molecular weight of at least 100,000.

24. A method according to claim 1, wherein said at least one selective flocculation polymer has a molecular weight of at least 1,000,000.

25. A method according to claim 1, wherein said selecting at least one selective flocculation polymer comprises measuring the measured anionicity value by a titration method.

26. A method according to claim 1, wherein said suspension comprises said kaolin particulate material in an amount ranging from about 10% to about 15% by weight, on a dry weight basis, prior to said selective flocculating.

27. A method according to claim 1, wherein said at least one selective flocculation polymer is present in an amount ranging from about 0.01% to about 0.5% by weight, based on the dry weight of the kaolin particulate material.

28. A method according to claim 1, wherein said at least one selective flocculation polymer is added to said suspension in the form of a solution comprising said at least one polymer.

29. A method according to claim 28, wherein said at least one selective flocculation polymer is present in the solution at a concentration ranging from about 0.025% to about 0.25%.

30. A method according to claim 28, wherein said at least one selective flocculation polymer is present in the solution at a concentration of about 0.075%.

31. A method according to claim 1, wherein said second layer has a specific gravity ranging from about 1.001 to about 1.030

32. A method according to claim 1, wherein said second layer has a specific gravity ranging from about 1.001 to about 1.004.

33. A method according to claim 1, wherein said selective flocculating comprises mixing said suspension.

34. A method according to claim 1, further comprising redispersing said separated flocculated product layer and then selectively flocculating said redispersed layer.

35. A method for the treatment of kaolin particulate material comprising:
(a) providing a dispersed aqueous suspension of said kaolin particulate material having a pH of at least about 7.5;
(b) selecting at least one selective flocculation polymer, wherein said at least one polymer has a narrow range of variability for measured anionicity and has a measured anionicity ranging from about 1% to about 12%;
(c) selectively flocculating said suspension with adjusted pH into a first layer and a second layer by adding to said suspension said at least one polymer; and
(d) separating said first layer from said second layer.

36. A method according to claim 35, wherein said at least one selective flocculation polymer has a measured anionicity ranging from about 4.5% to about 8%.

37. A method according to claim 35, wherein said at least one selective flocculation polymer has a measured anionicity ranging from about 6% to about 7%.

38. A method for the treatment of kaolin particulate material comprising:
(a) providing a dispersed aqueous suspension of said kaolin particulate material having a pH of at least about 7.5;
(b) selecting at least one selective flocculation polymer, wherein said at least one selective flocculation polymer has been manufactured by a continuous process and has a measured anionicity ranging from about 1% to about 12%;
(c) selectively flocculating said suspension with adjusted pH into a first layer and a second layer by adding to said suspension said at least one selective flocculation polymer; and
(d) separating said first layer from said second layer.

39. A method according to claim 38, wherein said at least one selective flocculation polymer has a measured anionicity ranging from about 4.5% to about 8%.

40. A method according to claim 38, wherein said at least one selective flocculation polymer has a measured anionicity ranging from about 6% to about 7%.
